(19) United States
(12) Patent Application Publication
(10) Pub. No.: US 2006/0012884 A1
(43) Pub. Date: Jan. 19, 2006

(54) Portable diagnostic system with heads-up display

(75) Inventors: Lee M. Snorteland, San Jose, CA (US); James Cancilla, San Jose, CA (US)

Correspondence Address: McDERMOTT WILL & EMERY LLP, 600 13th Street, N.W., Washington, DC, 20005-3096, US

(73) Assignee: Snap-On Incorporated

(21) Appl. No.: 10/888,997

(22) Filed: Jul. 13, 2004

(51) Int. Cl. G02B 27/14

(52) U.S. Cl. 359/630

(57) ABSTRACT

A heads-up system includes a diagnostic tool and a heads-up display for displaying information from a vehicle. The diagnostic tool connects to a communication bus of the vehicle. The display includes a projection device and an input module that is connected to the diagnostic tool either wirelessly or with a wire connection. The input module may translate signals from the diagnostic tool into signals readable by the projection device.

### TECHNICAL FIELD

The disclosure relates generally to automotive service systems and, more specifically, to a portable diagnostic tool that can be used in a vehicle during the operation of the vehicle.

### BACKGROUND ART

During the servicing of a vehicle, such as an automobile, it has become increasingly important to be able to monitor the operations of major vehicle systems, such as the engine, transmission and braking system, on a real-time basis for diagnosing and repairing operational problems. These major systems are usually controlled, either entirely or in part, using a microcomputer, and the on-board ability of controllers within the vehicle to store operational information and error codes for later retrieval has been exploited to improve the accuracy with which service personnel diagnose vehicle problems. However, these controllers have limited on-board memory for storing these operational parameters. Thus, auxiliary diagnostic systems have been developed to supplement on-board capabilities of the controllers.

One commonly employed auxiliary diagnostic system is commonly known as a “scan tool” or “scanner.” The scanner is typically hand-held and interfaces to the automobile's on-board controllers via a vehicle communication bus, usually tapping into the bus at a connection point located beneath the dashboard or a seat. When a vehicle is brought in for repair or a checkup, the scanner is used to help diagnose or discover any problems in the various monitored systems of the vehicle.

An issue associated with these scanners is that a problem may exist when the vehicle is being operated, but the problem will not manifest itself while the vehicle is in the shop. One solution to this problem has been the development portable scanners that can be used outside of the shop. Using these portable scanners, the technician takes the vehicle out for a test run and tries to recreate the situation(s) in which the problem manifests itself. The technician can then monitor the operating conditions of the vehicle using the portable scanner at the time when the problem surfaces.

These portable scanners are a hand-held, self-powered version of the prior auxiliary diagnostic systems. When the technician is trying to diagnose the problem while driving, the technician has to take his or her eyes off the road to look at the scanner since the display device for the scanner is located on the scanner itself. This creates two problems. First, the technician is placed in a dangerous position by being forced to constantly take his or her eyes of the road, and second, the technician receives only “snap-shots” of information instead of a real-time full stream of data. There is, therefore, a need for a portable diagnostic tool that enables a technician to keep his or her eyes on the road while still providing the technician with a real-time, full stream of operations data from the vehicle.

### SUMMARY OF THE DISCLOSURE

Described is a heads-up system for a user of a vehicle, such as an automobile, to obtain operational information from a controller of a vehicle while the user is operating the vehicle. The system includes a diagnostic tool and a heads-up display for displaying the information. The diagnostic tool is connected to a communication bus of the vehicle. The display includes a projection device and an input module that is connected to the diagnostic tool either wirelessly or with a wire connection. The input module may translate signals from the diagnostic tool into signals readable by the projection device.

The display can be worn by the user or mountable within the vehicle. If worn by the user, the display can project the information directly onto an eye of the user. Alternatively, the display may include a lens onto which the display projects information. The display may also be a direct-view display configured to be positioned within the field of view of the user. If the display is mountable within the vehicle, the display may project information onto an optically-transparent screen, such as a windshield, of the vehicle with a projector. Alternatively, the display can interface with a projector already present within the vehicle. The mountable display may also be a direct-view display positioned within the field of view of the user.

In another aspect of the heads-up system, a display controller is included for controlling content of the operational information from the diagnostic tool to display. A recorder can also be included to record of audio and operational information from the diagnostic tool.

Additional advantages will become readily apparent to those skilled in the art from the following detailed description, wherein only an exemplary embodiment of the present invention is shown and described, simply by way of illustration of the best mode contemplated for carrying out the present invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

FIG. 1 is schematic view of a heads-up system, according to the disclosure;

FIG. 2 is an example head-mounted, heads-up display for use with the heads-up system in FIG. 1;

FIG. 3 is another example of a head-mounted, heads-up display for use with the heads-up system in FIG. 1;

FIG. 4 is still another example of a head-mounted, heads-up display for use with the heads-up system in FIG. 1;

FIG. 5 is an example of a windshield-projector, heads-up display for use with the heads-up system in FIG. 1;

FIG. 6 is another example of a windshield-projector, heads-up display for use with the heads-up system in FIG. 1; and

FIGS. 7A and 7B are examples of a direct view, heads-up display for use with the heads-up system in FIG. 1.

### DETAILED DESCRIPTION OF THE PREFERRED EMBODIMENTS

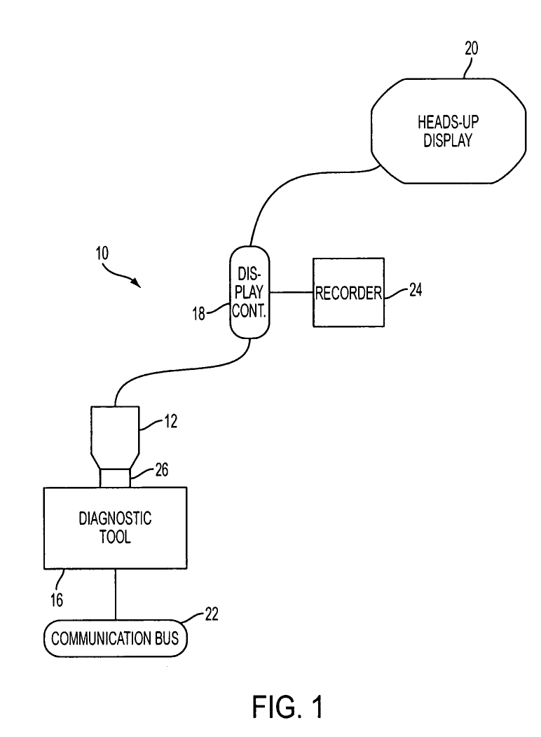

An example of a heads-up system 10 is illustrated in FIG. 1. The heads-up system 10 includes a heads-up display 20 connected to a diagnostic tool 16. The diagnostic tool 16 is connected to controllers (not shown) of the vehicle, such as an automobile, via, for example, a vehicle communication bus 22 that is part of the vehicle. The heads-up system 10 may be included in the diagnostic tool 16, or the heads-up system 10 may be connectable to the diagnostic tool 16. If the heads-up system 10 is connectable to the diagnostic tool 16, the heads-up system 10 includes an input interface 12 that is connected to an output port 26 of the diagnostic tool 16. Operational information regarding the vehicle is sent by the diagnostic tool 16 to the heads-up display 20.

Information that can be provided by the diagnostic tool 16 can be any information related to the past and/or present performance and/or operations of the vehicle. This information may include, but is not limited by, the following: the actual distance traveled by the vehicle; the date and times of specific events, such as the time the vehicle was started, the time the vehicle was stopped and the elapsed time of engine operation; vehicle conditions, such as a threshold or maximum engine load experienced by the vehicle during operation; the current odometer reading; the current revolutions per minute of the engine; vehicle status, fault, or error conditions experienced during operation, such as engine oil pressure, engine oil temperature, engine coolant temperature, engine alternator current or voltage output, hydraulic fluid pressure, hydraulic fluid temperature, hydraulic fluid pressure; and the amount of consumables remaining in vehicle, such as fuel level, engine coolant level, engine oil level, and hydraulic fluid level.

The heads-up system 10 may also include a display controller 18. The display controller 18 can be used by the user of the heads-up system 10 to control the flow of data from the diagnostic tool 16 to the heads-up display 20. For example, the display controller 18 can, for example, be used to change the output of the diagnostic tool 16 from “revolutions per minute of the engine” to “oil temperature.” As another example, the display controller 18 can also be used to control the format of the information provided by the diagnostic tool 16. Other capabilities of the display controller 18 to manipulate the data from the diagnostic tool 16 to the heads-up display 20 are readily apparent to those skilled in the art.

In one aspect of the heads-up system 10, the display controller 18 operates either hands-free or with minimal manipulation by one hand. For example, the hands-free operation of the display controller 18 can be accomplished by voice-activation. Also, the display controller 18 can be adapted to be held in and operated by just one hand. In this manner, the display controller 18 can be operated by the user while the user drives the vehicle. In another example, the display controller 18 can be adapted to be easily attachable to/removable from a location on the vehicle, such as on the steering wheel or the dashboard, close to one of the hands. In this manner, a user can operate the display controller 18 with little movement of the hands. Types of the controllers that are adapted to be operated by voice activation or with little movement of the hands are well known in the art, and the heads-up system 10 is not limited to a particular controller so capable. Controllers so capable, for example, are found on portable audio devices that allow a user to navigate many menus with the use of just one hand.

The heads-up system 10 may also include a recorder 24, for example, connected to and operated by the display controller 18. The recorder 24 can be used to record all or some of the data being output by the diagnostic tool 16. Alternatively or in addition to recording data from the diagnostic tool 16, the recorder 24 can record audio comments from the user. These audio comments from the user can later be played back to help in diagnosing the condition of the vehicle. Also, if the recorder 24 records both the data being output by the diagnostic tool 16 and audio comments, the recorder 24 may track when the audio comments are made to when the data is produced so that comments can be later correlated to the data from the diagnostic tool at the time the comments were made. Types of the recorders that can record digital, analog and/or audio data either separately or together are well known in the art, and the heads-up system 10 is not limited to a particular recorder so capable.

The heads-up display 20 displays information from the diagnostic tool 16 so that a user can operate the vehicle and view the information at the same time, and the heads-up display 20 is not limited to the particular device/system used to display the information from the diagnostic tool 16. Examples of heads-up displays 20 capable of being used with the heads-up system 10 include a head-mounted device that projects the information directly into the eye/retina of the user; an eyeglass system that includes a projector for projecting information onto at least one of the lens of the eyeglass; a head-mounted direct-view system for displaying the information; a portable windshield projector for projecting information onto the windshield of the vehicle; an interface module for inputting the information into a pre-existing windshield projector for projecting information on the windshield of the vehicle; and a portable direct-view display device that may be affixed, for example, to the windshield of the vehicle. The heads-up system 10, however, is not limited as to these particular examples, and any heads-up display capable of being ported into a vehicle is acceptable for use with the heads-up system 10.

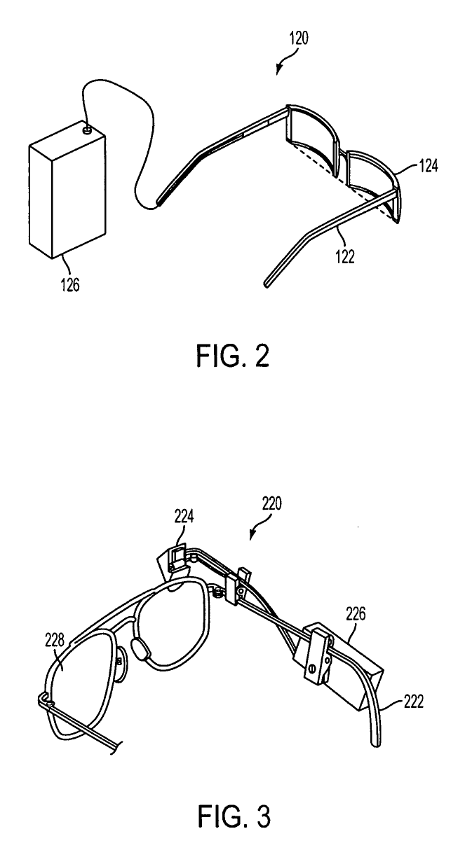

An example of a heads-up display 120 that projects information directly into the eye/retina of a user is illustrated in FIG. 2. A heads-up display 120 that projects information directly into the eye/retina of a user is known in the art, and any heads-up display 120 so capable is acceptable for use with the heads-up system 10. A heads-up display 120 so capable is illustrated and described in U.S. Pat. No. 5,653,751 to Samiy et al., incorporated herein by reference.

The heads-up display 120 includes a mounting device 122, a projection device 124, and an input module 126 connected to the projection device 124. The mounting device 122 positions the projection device 124 adjacent the eye/retina of a user. The input module 126 receives the information from the diagnostic tool 16 (not shown), which gets transferred to the projection device 124, and the projection device 124 directs the information as an image onto the eye/retina of the user. The signals received by the input module 126 are sent directly to the projection device 124 if the signals are already readable by the projection device 124, and if not, the received signals are translated by the input module 126 into signals readable by the projection device 124. The input module 126, although shown apart from the projection device 124, may be integrated into the projection device 124.

An example of a heads-up display 220 that includes a projector for projecting information onto an optically transparent screen, such as a lens of an eyeglass, is illustrated in FIG. 3. A heads-up display 220 that includes a projector for projecting information onto a lens of the eyeglass is known in the art, and any heads-up display 220 so capable is acceptable for use with the heads-up system 10. A heads-up display 220 so capable is illustrated and described in U.S. Pat. No. 3,945,716 to Kinder and U.S. Pat. No. 4,753,513 to Kubik, both of which are incorporated herein by reference.

The heads-up display 220 includes a mounting device 222, a lens 228, a projection device 224, an input module 226 connected to the projection device 224. The lens 228, which may be, for example, the lens of an eyeglass, is placed in front of the eyes of a user, and the mounting device 222 positions the projection device 224 adjacent the lens 228. The input module 226 receives the information from the diagnostic tool 16 (not shown), which gets transferred to the projection device 224, and the projection device 224 directs the information as an image onto the lens 228, which can then be viewed by the user. The signals received by the input module 226 are sent directly to the projection device 224 if the signals are already readable by the projection device 224, and if not, the received signals are translated by the input module 226 into signals readable by the projection device 224. The input module 226, although shown apart from the projection device 224, may be integrated into the projection device 224.

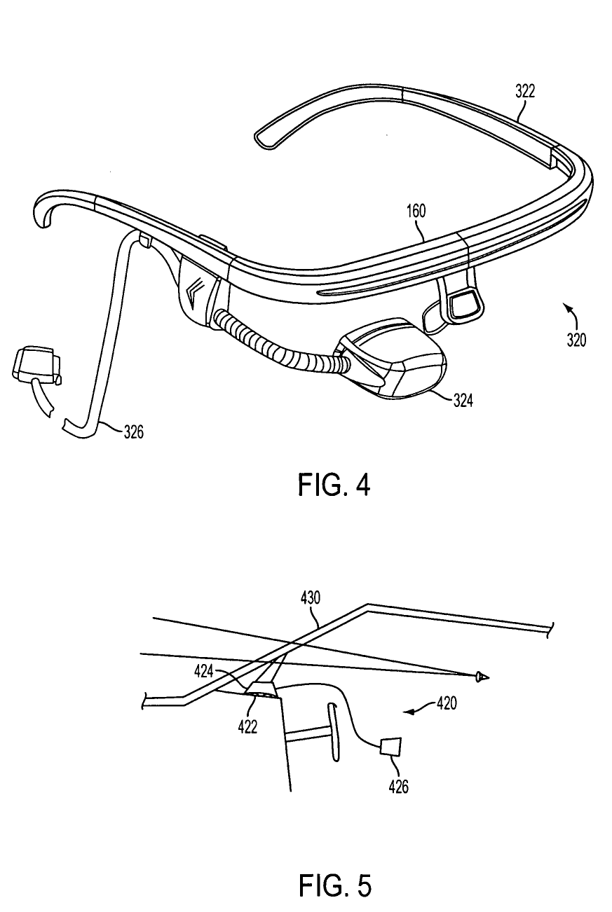

An example of a heads-up display 320 that includes a head-mounted direct-view system for displaying the information is illustrated in FIG. 4. A heads-up display 320 that includes a head-mounted direct-view system for displaying the information is known in the art, and any heads-up display 320 so capable is acceptable for use with the heads-up system 10. For example, a heads-up display 320 is illustrated and described in U.S. Pat. No. 4,636,866 to Hattori and U.S. Pat. No. 6,034,653 to Robertson et al., both of which are incorporated herein by reference.

The heads-up display 320 includes a mounting device 322, a direct-view projection device 324, and an input module 326 connected to the direct-view projection device 324. The mounting device 322 positions the direct-view projection device 324 adjacent the eyes of a user. The input module 326 receives the information from the diagnostic tool 16 (not shown), which gets transferred to the direct-view projection device 324, and the projection device 324 directly displays the information as an image viewable by the user. An example of such a direct-view projection device 324 is a LCD screen. The signals received by the input module 326 are sent directly to the direct-view projection device 324 if the signals are already readable by the direct-view projection device 324, and if not, the received signals are translated by the input module 326 into signals readable by the direct-view projection device 324. The input module 326, although shown apart from the direct-view projection device 324, may be integrated into the direct-view projection device 324.

An example of a heads-up display 420 that includes a portable projector for projecting information onto an optically transparent screen, such as a windshield of the vehicle, is illustrated in FIG. 5. A windshield projector 424 for projecting information onto the windshield of the vehicle is known in the art, and any windshield projector 424 so capable is acceptable for use with the heads-up system 10. For example, a windshield projector 424 is illustrated and described in U.S. Pat. No. 4,806,904 to Watanuki, incorporated herein by reference.

The heads-up display 420 includes a mounting device 422, a windshield projection device 424, and an input module 426 connected to the projection device 424. The heads-up display 420 is mounted within the vehicle using the mounting device 422 such that projection device 424 projects onto the windshield 430 of the vehicle. The mounting device 422 allows the heads-up display 420 to be easily mounted/removed from the vehicle. The mounting device 422 also keeps the heads-up display 420 from being moved during motion of the vehicle. Mounting devices 422 so capable are well known in the heads-up display 420 is not limited as to a particular type of mounting device 422. An example of a mounting device 422 so capable is an array of suction cups.

The input module 426 receives the information from the diagnostic tool 16 (not shown), which gets transferred to the projection device 424, and the projection device 424 directs the information, as an image, onto the windshield 430, which can then be viewed by the user. The signals received by the input module 426 are sent directly to the projection device 424 if the signals are already readable by the projection device 424, and if not, the received signals are translated by the input module 426 into signals readable by the projection device 424. The input module 426, although shown apart from the projection device 424, may be integrated into the projection device 424.

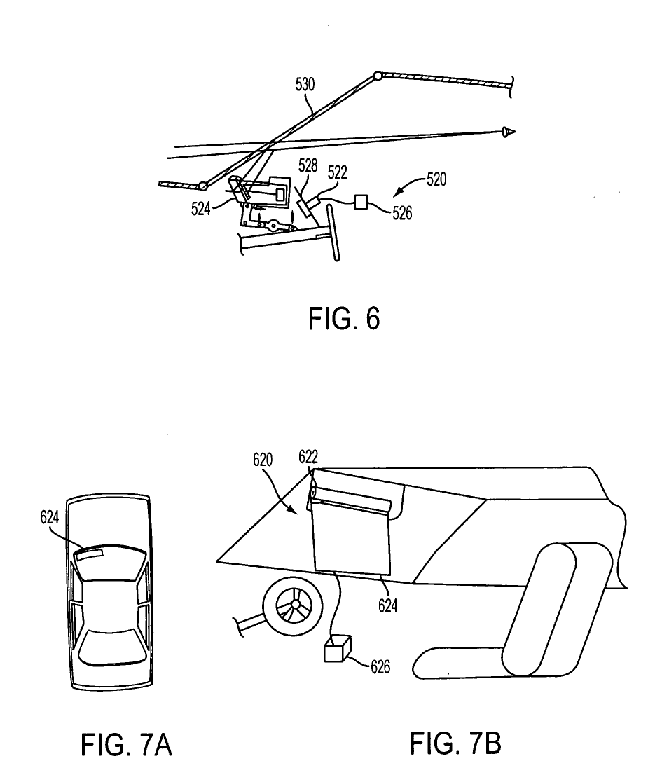

An example of a heads-up display 520 that includes an interface module for inputting the information into a pre-existing windshield projector for projecting information on the windshield of the vehicle is illustrated in FIG. 6 A windshield projector 524 for projecting information onto the windshield of the vehicle is known in the art, and any windshield projector 524 so capable is acceptable for use with the heads-up system 10. For example, a windshield projector 524 is illustrated and described in U.S. Pat. No. 4,806,904 to Watanuki, incorporated herein by reference.

The heads-up display 520 includes an interface module 522 and an input module 526 connected to the interface module 522. The interface module 522 is connected to an input port 528 of a windshield projector 524 already mounted within the vehicle The input module 526 receives the information from the diagnostic tool 16 (not shown), which gets transferred to the projection device 524 via the interface module 522, and the projection device 524 directs the information as an image onto the windshield 530, which can then be viewed by the user. The signals received by the input module 526 are sent directly to the projection device 524 via the interface module 522 if the signals are already readable by the projection device 524, and if not, the received signals are translated by the either the input module 526 or the interface module 522 into signals readable by the projection device 524. The input module 526, although shown apart from the interface module 522, may be integrated into the interface module 522.

An example of a heads-up display 620 that includes a direct-view system for displaying the information is illustrated in FIGS. 7A and 7B. A heads-up display 620 that includes a direct-view system for displaying the information is known in the art, and any heads-up display 620 so capable is acceptable for use with the heads-up system 10. For example, a heads-up display 620 is illustrated and described in U.S. Pat. No. 6,490,402 to Ota, incorporated herein by reference.

The heads-up display 620 includes a mounting device 622, a direct-view projection device 624, and an input module 626 connected to the direct-view projection device 624. The mounting device 622 positions the direct-view projection device 624 within the vehicle such that that projection device 624 is easily viewed by the user when driving the vehicle. The mounting device 622 allows the direct-view projection device 624 to be easily mounted/removed from the vehicle. The mounting device 622 also keeps the location of the direct-view projection device 624 from being moved during motion of the vehicle. Mounting devices 622 so capable are well known in the heads-up display 620 is not limited as to a particular type of mounting device 622. An example of a mounting device 622 so capable is an array of suction cups. Another example of a mounting device 622 is a clip that can be hung, for example, onto a sun visor within the vehicle.

The input module 626 receives the information from the diagnostic tool 16 (not shown), which information is transferred to the direct-view projection device 624, and the projection device 624 directly displays the information as an image viewable by the user. An example of such a direct-view projection device 624 is a LCD screen. The signals received by the input module 626 are sent directly to the direct-view projection device 624 if the signals are already readable by the direct-view projection device 624, and if not, the received signals are translated by the input module 626 into signals readable by the direct-view projection device 624. The input module 626, although shown apart from the direct-view projection device 624, may be integrated into the direct-view projection device 624.

Although the various sub-systems of the heads-up system 10 are shown in the drawings as being directly connected, the heads-up system 10 is not limited in this manner. The information passed to and from the diagnostic tool 16, the communication bus 22, the heads-up display 20, the controller 18, and the recorder 24 can be wirelessly, such as by infrared signals or radio signals, or via a direct connection, such as with a electrical cable or by fiber optics. The communication of information to and from the various sub-components of the heads-up displays 220, 320, 420, 520, 620 may also be wirelessly or by direct connections.

Through use of the present heads-up system 10, a technician can keep his or her eyes on the road while being provided with a real-time, full stream of operational data from a controller of the vehicle. The heads-up system 10 also enables a technician to record this real-time data and audio comments by the technician for later use in diagnosing the condition of the vehicle.

The disclosed concepts may be practiced by employing conventional methodology and equipment. Accordingly, the details of such equipment and methodology are not set forth herein in detail. In the previous descriptions, numerous specific details are set forth, such as specific processes, techniques, etc., in order to provide a thorough understanding of the present invention. However, it should be recognized that the present invention may be practiced without resorting to the details specifically set forth.

Only an exemplary aspect of the present disclosure and but a few examples of its versatility are shown and described. It is to be understood that the present invention is capable of use in various other combinations and environments and is capable of changes or modifications within the scope of the inventive concept as expressed herein.

1. A system for obtaining vehicle operational information from a controller of a vehicle during vehicle operation, comprising:
a diagnostic tool adapted to be connected to a communication bus of the vehicle; and
a heads-up display device for the diagnostic tool information, derived from the communication bus, on a windshield of the vehicle while a user is operating the vehicle.

2-6. (canceled)

7. The system according to claim 1, wherein the heads-up display device comprises a projector configured to project the information onto the vehicle windshield within the field of view of the user.

8. (canceled)

9. The system according to claim 1, further comprising a display controller for controlling content of the diagnostic tool information.

10. The system according to claim 1, further comprising a recorder for recording the diagnostic tool information.

11. (canceled)

12. The system according to claim 13, wherein the input module is configured to translate signals from the diagnostic tool into signals readable by the projection device.

13. The system according to claim 7, wherein the heads-up display device further comprises an interface module coupled to the projector and an input module coupled to the diagnostic tool.

14-30. (canceled)

31. A diagnostic system comprising:
a scanner configured to be detachably coupled to a communication bus of a vehicle to derive vehicle information therefrom while the vehicle is in operation; and
a heads-up display device coupled to the scanner for displaying output from the scanner on a windshield of the vehicle.

32. A diagnostic system as recited in claim 31, wherein the heads-up display device comprises a projector configured to project scanner output information onto the vehicle windshield within the field of view of a driver of the vehicle while maintaining windshield background visibility when the vehicle is in operation.

33. A diagnostic system as recited in claim 32, wherein the heads-up display device further comprises an input module coupled between the scanner and the projector, the input module comprising a controller for controlling content of the scanner information to be displayed and for translating signals received from the diagnostic tool into signals readable by the projection device.

34. A diagnostic system as recited in claim 33, further comprising a recorder coupled to the scanner and configured to store vehicle operational information.
